(19) United States
(12) Patent Application Publication
(10) Pub. No.: US 2020/0065312 A1
(43) Pub. Date: Feb. 27, 2020

(54) SYSTEM AND METHOD FOR THE COMBINATION OF APP DATA AND EXTERNAL DATA KEEPING THEM SEPARATE AND INDEPENDENT

(71) Applicant: Noam Camiel, Tel Aviv (IL)

(72) Inventor: Noam Camiel, Tel Aviv (IL)

(21) Appl. No.: 16/546,239

(22) Filed: Aug. 20, 2019

Related U.S. Application Data
(60) Provisional application No. 62/720,117, filed on Aug. 21, 2018.

(51) Int. Cl. G06F 16/25; G06F 11/30; G06F 3/0484; H04L 29/08; G06F 21/50

(52) U.S. Cl. CPC G06F 16/254; G06F 11/3013; G06F 2212/171; H04L 67/34; G06F 21/50; G06F 3/04842

(57) ABSTRACT

A system and method is introduced for extracting application data and binding the application data and external existing data for generating actions and events. The scanning of application output data may be done independently of the applications and no data is revealed to the applications solving privacy issues, security issues as well as revenue sharing issues. Furthermore, application behavior is monitored based on its output to reveal anomalies. Such anomalies may be mitigated or sent to SOC for whitelisting or blacklisting. This mitigation may allow time to handle crisis situations and buy time for security firms to solve problems while allowing messages to arrive from the vendor rather than from an attacker. User input may be added to the extracted application data to reveal application bugs, issues and hacking attempts. Digital signs may be monitored and their display mitigated in case of a hacking attacks on the content displayed by the digital signs.

### CROSS-REFERENCE TO RELATED APPLICATIONS

This application claims the benefit of U.S. Provisional Patent Ser. No. 62/720,117 filed Aug. 21, 2018 by the present inventor.

U.S. application Ser. Nos. 14/231,482 and 14/231,500 by the present inventor are referred to in this application and herein incorporated in their entirety by reference into the specification. Herein referred to as the initial applications.

U.S. application Ser. No. 15/376,641 filed Dec. 12, 2016 by the present inventor is referred to in this application and herein incorporated in its entirety by reference into the specification. Referred to herein as secondary application.

U.S. application Ser. No. 15/893,667 filed Feb. 11, 2018 by the present inventor is referred to in this application and herein incorporated in its entirety by reference into the specification and referred to herein as third application.

### FIELD OF INVENTION

This invention generally relates to connecting, extracting data and securing computing systems and more particularly but not exclusively to extract and bind data from separated applications with external data allowing them to work together.

### BACKGROUND OF THE INVENTION

Computing devices and platforms are built for executing applications, herein apps. These computing devices includes the likes of tablets, mobile phones, pcs, car infotainment systems and so forth.

Applications that run on these computing platforms have valuable data that is available only to those apps. If the computing device manufacturer or platform owner wants to get a hold of this data, they usually need to work together with the app vendor.

On the other hand, if the platform owner has data that, in combination with the app data can generate valuable transactions, this data needs to be combined with the application data, while this data may be sensitive and needs to be safeguarded.

The present disclosure allows the platform owner to make use of app data displayed on the display to combine with their data, without the need for integration, data sharing, permission or sharing of revenue.

An issue with computational devices and platforms is their susceptibility to cyber attacks. The cyber attacks may be launched for different reasons causing potentially catastrophical consequences for the platform maker as well as the end customer.

Different types of cyber attacks that effect the end user are possible. Among these, one type of cyber attack is a ransomware attack, displaying the end user with a ransom message. Another type of attack is sending the user a false message imitating a real message. Another type of attack is altering user input to apps changing their way of operating. An example of this would be altering of a Waze destination address causing the vehicle to navigate to a false location. Other attacks or bugs may make the app to have unpredicted behavior.

Scanning of the display and scanning user input may be used for accomplishing above and other requirements. Scanning of the display may reveal app data and current user state based on the apps viewed and used. Scanning of user input, like touchscreen and other input means such as buttons on the wheel for example, can reveal a user requested command as opposed to a hacked request.

Let us look at the cars and specifically infotainment systems in cars, dashboard and other interactive or viewable screens in the car.

The car is fast becoming a consumer oriented platform. Many players want a piece of the pie. This includes app makers, operating system makers, infotainment manufacturers and vehicle OEMs.

The car OEM controls the car and its data but not the apps. The OEM is expected to share their platform and data with app makers and split the profits.

It is an object of the present disclosure to allow users to use their apps while the OEM is able to utilize app data for generating revenue, without the involvement of the app maker. This includes using phone screen projection such as Android Auto and Apple CarPlay where the phone screen may be scanned by the infotainment and user input may be scanned by the infotainment.

It is an object of this disclosure to allow the combining of app data with car data to generate revenue and added value services to the end users as well as for other ends.

Sharing data with 3^{rd} party apps is also an issue that needs to be addressed. There are regulations and requirements in different countries regarding data privacy and it would be advantageous to offer a way to utilize car data along with app data in a way that does not share car data with 3^{rd} party apps.

Therefore with car historical and current data along with app I/O data the OEM can offer value added services and monetize their platform. Furthermore, these services may be offered without the user data being shared with any party, such as in-car decision making or automatic in-cloud decision making, without keeping or sharing the data.

These services may be implemented as follows. Scanning the infotainment display and processing any app data displaying on the screen. The processing may be done in any way and combination of computer vision, OCR, AI, machine learning etc. The data that is processed may be combined with other car data to generate certain events.

For generating these events no integration or sharing of car data with the apps is necessary. Furthermore, no agreements or revenue sharing may need to take place. This leaves the car OEM independent and in control of their data and platform.

For example imagine a sat-nay 3^{rd} party application that prints the ETA or estimated time of arrival, on the screen. With current and past car data and scanning of the ETA a conclusion can be made regarding a necessary stop for food/refreshments. With the knowledge of the car location a match to an affiliate place to stop may be made with an incentive such as an offer for something such as free coffee.

This way, car data is merged with 3^{rd} party app data to deliver an event with monetizing capabilities for the car OEM, without sharing car data and without integration with the 3^{rd} party app provider.

The way of accessing app data by scanning the display allows to get app data from the phone screen that is projected to the infotainment screen such as in the case of Android Auto and Apple CarPlay. Once the app appears on the infotainment screen the scanning of the screen will pick the app information up.

In this example a car is used but other platforms are relevant for this disclosure as well.

The implementation of this technology may be implemented on a separate physical device, a single processor with separation technology such as ARM Trustzone or on the same operating system environment and using a hypervisor. There is no limitation to the possible ways of implementing this technology, each of which has its own advantages and disadvantages. We will explain a secure and non secure approach later on in the application.

Another use of the present disclosure is to allow checking of the expected behavior of a program for bugs or hacking checks. For example, it is possible to check the displayed images and check if these are expected. This is relevant for app checking as well as for video or stills display so for example, digital billboards or digital signage may use this technology for checking if the displayed images are expected or otherwise not wanted.

Another example for checking the expected behavior of a program is if a Waze sat-nay application, changes the destination without the user intervening. In such a case a destination change is detected through the app display while the user input means do not detect any user input requesting the change. This way hacking attempts may be discovered and mitigated.

The importance of implementing this technology in a separate environment such as “ac” environment a.k.a normal world environment for the app and “dc” environment a.k.a secure world for data from the car is that the app scanning and car data may be handled securely in the “dc” or secure world so that sensitive car data is not available in the normal world a.k.a ac side. This separation is important for implementing a secure service.

The scanning of I/O such as screen and input means such as touch and other input means may allow to protect against cyber attacks aimed at infecting customer interfacing I/O and applications.

As explained in application Ser. No. 15/893,667 by the present inventor, ransomware may be identified and mitigated at least to some extent by such technology. Furthermore, identification of application alteration by a cyber attack may be identified by scanning of the screen and input means from the user.

For example, a sat nav app may change destination in the middle of the drive. This may be discovered for example through scanning of the display. If no user input has been made to change the destination a prompt may be presented to the user to confirm the new destination which will be removed otherwise.

In all such cases, either in ransomware or other cyber attack situation, some mitigation may be offered locally while the car OEM SOC or other SOC may be notified of the event.

There may also be events where a ransomware or other attack is suspected and the SOC is sent a request for review to either white list or black list the case. Following deciding whether to white list or black list, this information may be sent to all cars of the OEM.

The present disclosure has the ability to discover attacks arriving from the attackers that are aimed at the end user and may offer to mitigate them immediately to some extent while notifying the SOC for further mitigation.

It is an object of the present disclosure to hide any message arriving from attackers so that all messages arrive from the car OEM in any case.

This is important both for driver safety such as the shock of receiving a ransomware in the middle of a drive, as well as for the car OEM brand reputation, which may be in trouble if the ransomware message or other attacks are noticed and publicized.

In case of a cyber attack it is always the task of cyber security companies to prevent them while the aim of this disclosure is to help discover and to allow to bridge the time between discovery and identification and mitigation.

The different use cases presented may be carried out by scanning of the display and user input, and processing of this data to understand the current situation. In some cases this may be enough and in others, together with other data from the platform, such as car data it is possible to generate events independent of any other app for better customer experience and greater control of the car OEM as well as monetization possibilities to the OEM.

The secure car data and data from scanning the apps may be sent to the vendor cloud or service cloud, preferably from the secure, dc side. This data may then be processed and events may be initiated for the car based on vendor decisions. This may include monetization decisions such as affiliate locations and so forth.

In some cases other cars such as in the vicinity or in a relationship with the car such as in the same fleet or other relation may communicate this data securely for reasons such as security or monetization.

The present disclosure further allows the scanning of apps on a display for extracting data from the apps and for monitoring the apps for possible hacking attempts such as changes that require user input where user input was suspected to not have been entered.

Input means may be any possible input means such as audio, video, touch screen, buttons on the wheel etc.

Revealing of attack attempts and mitigating them to an extent until a full fix is available is one of the features of this application It is preferable that during a successful attack that bypassed existing security measures, all messages arrive from the car OEM and not from the attackers, which is a feature of the present application.

Attacks that are revealed and mitigated may be fake messages and ransomware as well as app modifications that normally requires user input to make.

Attacks may be mitigated or send to SOC for whitelisting or blacklisting. This mitigation may allow time to handle crisis situations and buy time for security firms to solve problems while allowing messages to arrive from the vendor rather than an attacker.

In some embodiments a system is presented for understanding what is displayed on the screen from looking at the screen and in some embodiments this understanding takes place from outside the context of the apps or operating system. As a result of such analysis action may be triggered, issues may be whitelisted and blacklisted as well as other actions taken.

There is thus a widely recognized need for this technology and services and it would be highly advantageous to have such a method devoid of the above limitations.

### SUMMARY OF THE INVENTION

A system and method is presented for analyzing data appearing on displays and also combining the data with other existing data arriving from other sources. The display presents data which may be processed and combined with data arriving from other sources to generate new data may can be used for generating new events. The data presented on the display which is of interest may be understood by various means for use such as event generation.

The data appearing on the display may be analyzed for cyber attacks or bugs based on issued such as expected behavior or checking user interaction.

The data appearing on the display may be extracted and analyzed externally to apps running, external to operating system running the apps, external to the chip and to the device.

Furthermore, a system and method is presented for preventing attacks that alter user input or change the user requested choice by different means such as mimicking user input or altering user data.

Furthermore, a system and method is presented for identifying attacks appearing on the display and notifying a SOC, either for a reporting of incident or for a confirmation or whitelist of a suspected attack.

These services may be based on the ac/dc net architecture in application Ser. No. 15/376,641.

Furthermore, according to one aspect of the present invention, there is provided a system for analyzing and extracting data from apps displayed on a display comprising:
a computing device comprising said display and configured to run said apps within an operating system;
a display scanner for scanning said display externally to said apps displaying on said display;
whereby output of said display scanner is analyzed to extract app data displayed on said display externally to said apps running on said computing device.

According to a second aspect of the present invention, there is provided a method of extracting data from apps displaying on a display of a computing device comprising:
a. displaying app data on said display;
b. scanning of said display externally to running of said apps displaying on said display;
c. analyzing scanned display data from said scanning to extract data displayed by said apps.

According to a third aspect of the present invention, there is provided a system for monitoring expected display output comprising:
a computing device comprising a display and configured to display prepared contents;
a display scanner for scanning said display externally to mechanism displaying said contents;
a display blocker for blocking at least part of displayed data on said display.
   wherein output of said display scanner is analyzed against said contents to identify data not included in said contents and block at least part of said data from displaying on said display.

Unless otherwise defined, all technical and scientific terms used herein have the same meaning as commonly understood by one of ordinary skill in the art to which this invention belongs. The materials, methods, and examples provided herein are illustrative only and not intended to be limiting

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustration of a data analyzer receiving data from app scanner and external data, in accordance with an embodiment of the present invention;

FIG. 2 is a block diagram illustration of two security worlds separating between apps and scanning functions, in accordance with an embodiment of the present invention;

FIG. 3 is a schematic flowchart for steps carried out for generating events based on scanned data and external data, in accordance with an embodiment of the present invention;

FIG. 4 is a schematic flowchart for steps carried out for identifying suspicious app behavior, in accordance with an embodiment of the present invention;

FIG. 5 is a schematic flowchart for steps carried out for reporting events based on set rules when monitoring apps, in accordance with an embodiment of the present invention;

FIG. 6 is a block diagram illustration of the modes in an ARM core implementing the secure extensions used for implementing the different worlds of security, in accordance with an embodiment of the present invention;

It will be appreciated that, for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated among the figures to indicate corresponding or analogous elements.

### DESCRIPTION OF THE PREFERRED EMBODIMENTS

The preferred embodiments teach extracting data displayed to users on a display, analyzing the data, optionally combining the data with external data sources to generate events of interest.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention includes several embodiments that can be realized for implementing solutions that analyze data displayed on displays or screens.

An application or app is displayed to the user through the screen and a scanning unit, either locally or from a secure location scans the display for data. This data may then be combined with data external to the unit as well as data that is internal to the unit.

An analysis engine combined the data and decides, based on a defined criteria to carry out certain commands or send events to cause certain actions.

One example of the preferred embodiments is a sat-nay (a satellite navigation utility or app) application that presents data to the user. A scanning device may scan the display in an independent way to the app and extract data such as how long until the destination.

Together with car data that says how long has the car been driven, how long is left for the current drive and GPS location of the car, the system may suggest to the driver to stop by a nearby place that is affiliated to the OEM. The system may apply a coupon or other incentive for the driver to make the stop.

Another aspect of this disclosure is attempts of detecting hacking attempts or bugs. With the ability to scan the display and analyze it independently, it is possible to follow the activities of the applications and make sure they behave as expected, i.e. according to specified rules. In some embodiments this capability of detecting hacking attempts or bugs may include access to the user input such as keys pressed in the car or touch screen information and so forth. Combining the data from the display and from the user input may assist in revealing such issues.

As an example of the preferred embodiments to hacking attempt or bug discovery, a sat-nay application is monitored where the programmed destination of the sat-nay app has changed without any user input. The system senses the change of destination by scanning the display. The system senses user input through several means such as touch screen, key by the wheel, voice commands etc.

If the address change in the sat nav app has occurred without detected user input the system may request the driver to authorize the destination change. Please note that the authorization request may arrive from the DC also known as secure world part, to make sure the attack if any, does not reach that secure system. Otherwise, an attacker may be able to block such warnings for example.

Another example of the preferred embodiments includes scanning of the screen and finding suspicious data. In such a case the SOC may determine if this input is considered an attack and may whitelist or black list this type of message. This way the system may learn and develop.

In the case where a match for an attack has been confirmed, the SOC may also be informed.

It has been stated the importance of the separation between the scanning of the display and the apps environment. This is important for reasons such for keeping attackers out of reach of systems aimed at sensing them and informing about them. Furthermore this is important for the privacy and security of the user where their data is kept separately and inaccessible to other apps.

The implementation of the display scanner and the secure area may be done in different manners, depending upon the requirements. One implementation of the separate secure area may take place using a single chip that has separation mechanisms such as ARM TrustZone or Intel Management Engine and may use isolation mechanisms such as Analog Devices Blackfin secure boot. Other isolation mechanisms may use hypervisors of type 1 or 2 or a combination of them to achieve separation with secure path. Other isolation mechanisms may use different hardware or hardware parts, such as be located at the display card, display card firmware, display driver or display chip that is separated from the CPU in different ways.

Another use of the preferred embodiment is to check the display for expected input to make sure the displayed information is expected and not malicious content of contents displayed as a bug for example.

An example of the preferred embodiment is checking displays in public locations that display images of clips to the public. A system of the present disclosure may check the displayed content and make sure no other content is displayed, removing or hiding unwanted imagery. A hacker for example, may attack a display located in the public, situated by an advertiser for example, and play malicious content such as scary, political or offensive material. The current disclosure is capable of detecting and blocking such data.

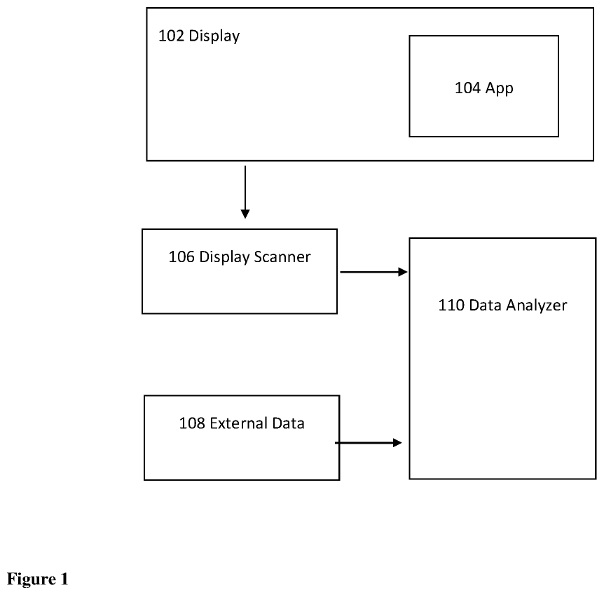

Reference is now made to FIG. 1, which is a block diagram illustration of a data analyzer receiving data from app scanner and external data, in accordance with an embodiment of the present invention comprising display 102 displaying app 104. A display scanner 106 scans the display 104 and outputs the data to a data analyzer 110. The data analyzer further received data from external sources such as car data, which may include various data from the car as well as GPS.

The data is combined by the data analyzer 110 to generate actions or events based on the data and possibly other existing data available from a database, from the internet etc. The data analyzer may be located at the cloud or locally in the car. Actions and events may be directed to within the car and outside possibly to the cloud.

It is preferable to implements the display scanner, the external data received and the data analyzer in a separate physical environment or semi physical environment so that a potential attacker will not be able to manipulate this data. In some other environments this may not be necessary, such as when the object of analysis is not of malicious nature.

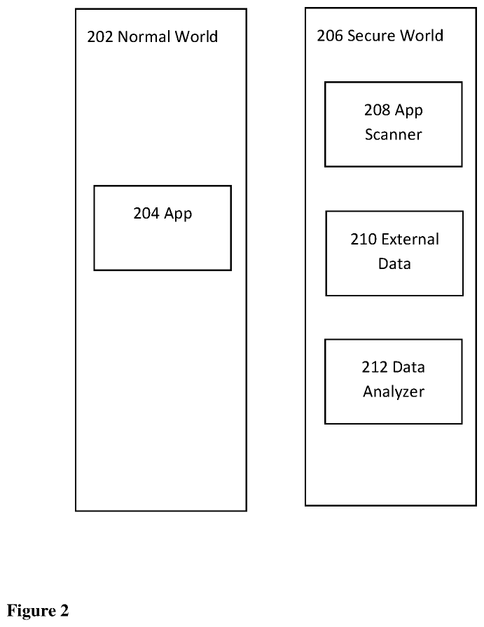

Reference is now made to FIG. 2, which is a block diagram illustration of two security worlds separating between apps and scanning functions, in accordance with an embodiment of the present invention, comprising Normal world or AC world 202 which may also be referred to as normal world in terms of ARM Trustzone securing technology from ARM. In the normal world or AC world, app 204 is executing. Secure World DC 206 like the the secure world of ARM Trustzone where a program in AC World 202 cannot access DC World 206 through hardware means. App scanner 208 is executing in DC world which scans output of executing app such as display, audio etc. The scanned data is processed in this unit to generate app data.

Furthermore, in DC world 206 runs external data 210 which receives data from an external source in various means. This data may be car data for example.

Furthermore, in DC world 206 data analyzer which received app scanned data and car external data. It may also have history data and database data and access to a cloud or be carried out in the cloud. The data analyzer 212 generates actions and/or events based on the data it has.

The separation between secure world and normal world as in the present fig. is intended for example to safeguard the ability of a hacker to manipulate data analysis of data appearing from apps to users. This independency between the app and the analyzer safeguards the independence of the data analyzer for securely carrying out app and overall output inspection to detect unexpected modifications, unwanted user appearing messages, attacks on apps, access to sensitive car and other data and to protect the system itself.

Note the terms AC and DC for non secure and secure worlds are explained thoroughly in application Ser. No. 15/376,641 by the present inventor.

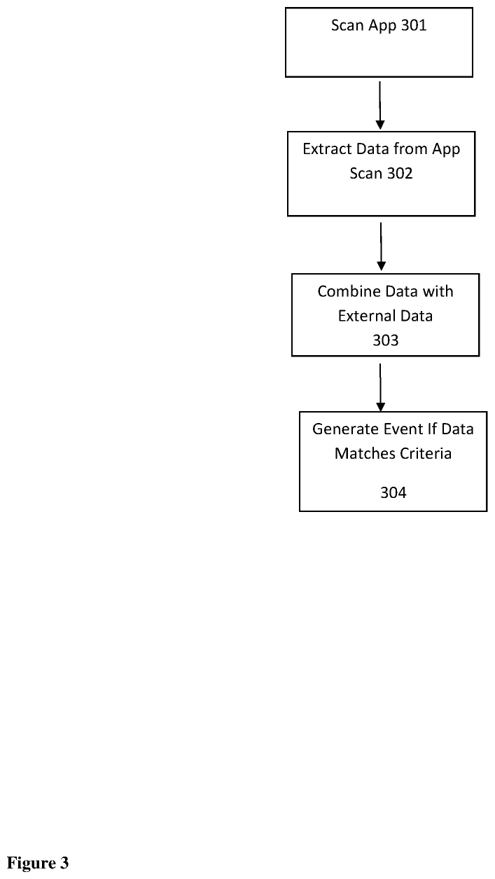

Reference is now made to FIG. 3, which is a schematic flowchart for steps carried out for generating events based on scanned data and external data, in accordance with an embodiment of the present invention;

In step 301, the app output is scanned by an app scanner. This may be done for the entire data output as well or several apps simultaneously, there is no limitations in this manner. This may be display output, audio output etc.

In step 302, data is extracted from the app scan to understand certain information from the app without needing to integrate with it or to work with the app maker. For example, a sat nav app may reveal how long the current ride still has to complete in regards to time and mileage by looking at the screen at a certain location and understanding it for example with the help of OCR.

In step 303 external data such as car data from various ECUs in the car which may also include GPS data is combined with the data arriving from the app scan and potentially other historical data or other database available, local or remote or on the cloud as well as data from the internet. This data combination may allow to reach certain conclusions. For example, from sat nav apps it may be possible to know how much is left for the current drive while it may be possible to know how long the car has been driving so far from car data and historical car data.

Combining both data from this example may assist an advertiser to get the driver to make a stop at their location by suggesting to make a stop at a relevant time as well as reword a stop by a coupon or discount.

In step 304 the data analysis engine or analyzer generates an event if the data it has matches a certain criteria, such as in the example, a long drive with an hour at least more to go, and a proximity of less than a mile from an affiliate location for example.

Such an event or actions may be generated to suggest the driver to stop by the affiliate location, perhaps with an incentive such as with a coupon or free coffee. The car OEM may be rewarded for pointing people at affiliate locations hence the reason for understanding app data and car data and combining them.

It is important to note that any revenues do not need to be split with the app maker and no integration with the app is needed. Furthermore car data does not need to be shared with the app maker to make this capability possible.

Therefore it is of importance to have this ability to be offered to companies such as car OEMs.

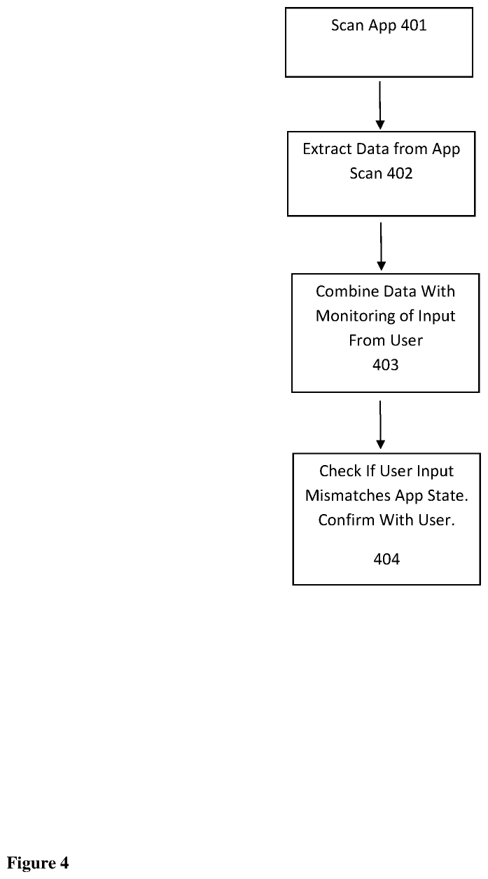

Reference is now made to FIG. 4, which is a schematic flowchart for steps carried out for identifying suspicious app behavior, in accordance with an embodiment of the present invention;

In step 401, the app output is scanned by an app scanner. This may be done for the entire data output as well or several apps simultaneously, there is no limitations in this manner. Output may be display or audio for example.

In step 402, data is extracted from the app scan to understand certain information from the app without needing to integrate with it with the app maker. For example, a sat nav app may reveal the current address it is traveling to by looking at the screen at a certain location. In other embodiments the current address may be placed at a certain time and location. The data may be understood with the help of OCR for example.

In step 403, app data from step 402 is combined with monitoring of input from the user. This input may be touch commands on the screen, buttons such as wheel buttons in cars, voice commands received etc.

This combination of data may help in understanding if an event has occurred that should only happen with user input taking place. If user input was not made or not properly made for such action then it may be detected that something suspicious is taking place. For example, a sat-nay change of destination took place without user request.

In step 404, we check if the user input mismatches the current app state. In one such case we confirm the state with the user. In other cases we may mitigate the situation in several ways, such as shut down the application, notify an SOC and also ask the user to confirm the current state. It is preferable that the question of authorization from the user be made in a different world of execution such as from the DC world (also known as secure world) when the app runs in the AC world (also known as normal world) so that an attacker is not able to mimic user actions. Furthermore working in another world for user authorization preferably will not disclose to attackers they were recognized and caught. In fact it is preferable that like in FIG. 2 the app scanner, external data and data analyzer be located in the secure world or DC world as well.

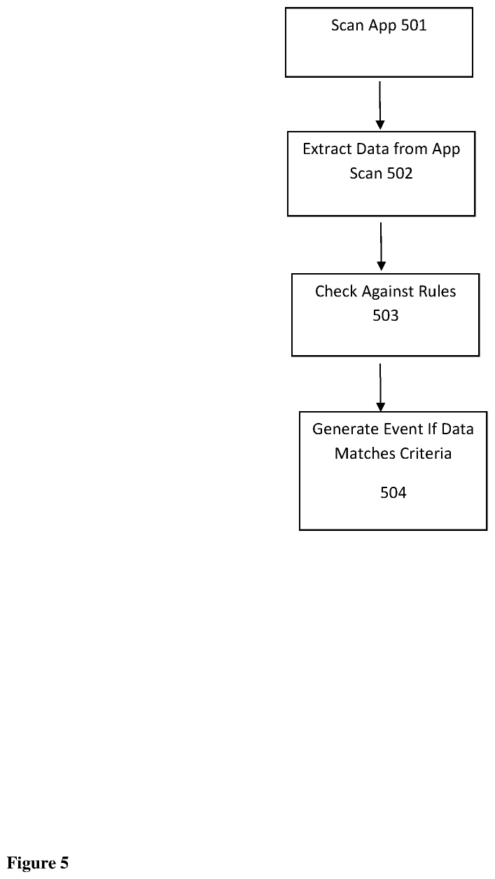

Reference is now made to FIG. 5, which is a schematic flowchart for steps carried out for reporting events based on set rules when monitoring apps, in accordance with an embodiment of the present invention;

In step 501, the app output is scanned by an app scanner. This may be done for the entire data output as well or several apps simultaneously, there is no limitations in this manner. Output may be display image or movie or audio for example.

In step 502, data is extracted from the app scan to understand certain information from the app or display as a whole without needing to integrate with the app maker. For example, a ransomware attack or an app is infected and launches an attack visible of user display. Fake messages may be displayed etc.

Understanding the data with the help of OCR, Computer vision, AI, deep learning etc may take place to identify these messages.

In step 503 the data from step 502 is checked against rules to check if the data received requires action. The rules may be white lists or black lists or both, so we can check for expected activity as well as for unexpected activity.

In step 504, based on step 503, events and actions are generated if data from step 502 matched criteria set of step 503. Data may be checked against a set of rules to be considered good and any deviation may be termed bad and removed or blocked. On the other hand a set of rules may be set for searching specific data and other data may be considered good. Information may be sent to SOC. In cases where an attack is suspected such also in new cases, the SOC may be requested to whitelist or black list certain output.

As an example, consider a screen placed in public that displays digital images and short clips. If an attacker gains control of the display it may cause severe damage to the company owning that display. For example, an attacker may display offensive content. It is an advantage to be able to check the images shown and block images that are outside the list of images currently allowed to be displayed. As an example of such a system, consider prepared contents being introduced into the system. The prepared contents is stored in a database to be compared against currently displays data. The system then displays the prepared contents while a display scanner scans the actual displayed data on the screen. An analyzer then analyzes the scanned screen and attempts to match the data displayed to the prepared contents. If the data displayed does not match the prepared contents, the image on the display is blocked at least in part. The blocking may be done in several ways, for example by darkening the screen, by replacing the images displayed to other images which may be part of the prepared contents or a message may be displayed. The scanning, analysis and blocking activities preferably take place outside the context of the displaying of data for security reasons, and may use Arm Trustzone, hypervisors etc.

These series of steps show how app scanning and output scanning generally may allow understanding attacks reaching the end users and mitigating them at least temporarily until a more thorough solution is made. For example, in case of a cyber attack that manages to bypass existing security means in cars. If the scanning of apps may identify such attacks it can help securing companies by detecting attacks as well as to buy time for the car OEM to deal with the problem.

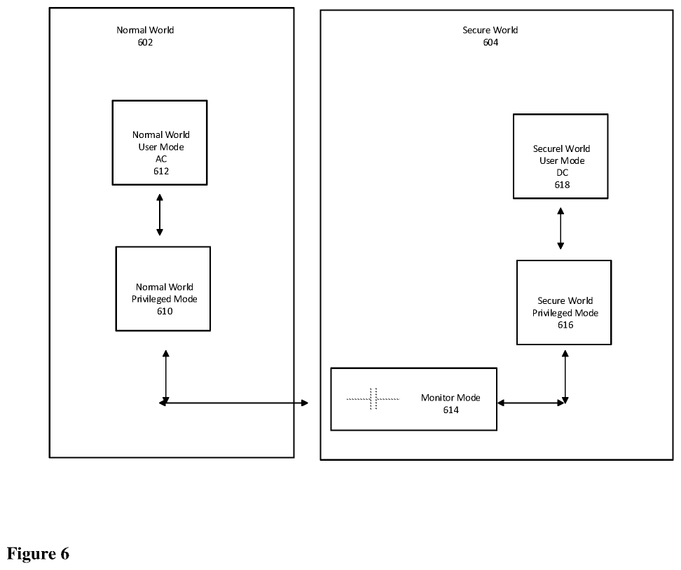

Reference is now made to FIG. 6, which is a block diagram illustration of the modes in an ARM core implementing the secure extensions used for implementing the different worlds of security, in accordance with an embodiment of the present invention comprising normal world ARM processor mode 602 and secure world ARM processor mode 604.

The normal world 602 includes normal world privileged mode 610 and normal world user mode 612 used for user device implementation, also referred to as ac operations. The secure world 604 includes monitor mode 614 used for the separation between user device and secure device also referred to as ad/dc adapter. The secure world privileged mode 616 and secure world user mode 618 are used for the secure device, also referred to as dc.

The monitor mode, used to switch between worlds is a special processor mode as described later. The monitor mode is connected to the normal world privileged mode 610 which is connected to the normal world user mode running user device or ac. The monitor mode 614 is connected to the secure world privileged mode 616 which is connected to the secure world user mode 618 used for secure device or dc operations. This way it is possible to implement a user device and a secure device with a separation mechanism that allows connection features as is referred to as ac/dc net device, on a single ARM chip utilizing both worlds and the monitor mode which stands in between them. The privileged modes assist in the separation, for example the secure world privileged mode which may help isolate the monitor from the user device or dc application.

FIG. 6 shows an example environment for applying external data extraction, so that the environment making the display data extraction is outside the environment of the applications and the operating system. This is advantageous for security, privacy when separation of the environments puts the extracted data outside the reach of the apps environment, which may be prone to attacks more than the data extracting environment.

The advantage of identifying attacks that manages to bypass existing secure systems and display to the user and preventing them from showing up helps to contain and control situations uncomfortable to a car OEM as well as being able to have all messages coming from the OEM rather from attackers.

The reference to ac/dc net is relevant to the language of U.S. application Ser. No. 15/376,641 referred to as the secondary application, referenced here in its entirety.

This application shows amongst other things, how scanning app by external means may reveal anomalies and assist in creating a revenue model. Input data from the user may help in these matters as well. Combined with data from the car, cloud, db historical, locationwise, affiliate lists etc can assist with this task. Scanning app output may be scanning of screen output, audio output, video output or other means.

The car is becoming a platform for customer business and many want to share in the revenue, namely app makers and OS makers.

The car OEM controls the car but does not have control over most of the apps which are controlled by the likes of Google, Apple and other third parties. The car data is in the OEM hands and app makers and platform makers want access to it in order to increase their revenues.

The car OEM does not want to share their data or split revenues.

The present disclosure allows an OEM to let their customers use their apps, even on the phone with Android Auto and Apple CarPlay, while being able to extract data from these apps independently and without sharing their data with the app maker.

Note that since Android Auto and Apple CarPlay and the likes project to the infotainment screen, scanning the screen of the infotainment and analyzing it may allow extracting of app data such as those projected to the OEM.

This allows the car OEM to monetize their platform and offer value added services to their customers without sharing their data.

The way this works is that the presented data analyzer knows the history and current car situation according to car data. Along with the information scanned from the apps and processed in any possible way such as OCR, computer vision algorithms, AI, machine learning, big data etc and a combination of them, it is possible to reach conclusions of interest for the OEM and their customers.

Information such as GPS location and affiliates locations may point at possible revenue possibilities as an example.

Monetization comes from the analysis of customers app use and car data as well as other possible existing data. This is done independently of the apps.

So for example, information of the time remaining for the drive may be extracted from a sat-nay application and be combined with total time driven so far to generate suggestions to stop at nearby affiliate locations.

Another example is looking at chat applications that request to purchase a certain item along the way (such as by using the word “get” or “buy”) and sending them to affiliate locations to get that item. This again is done independently of the app.

The result is that: 1) There is more information for the OEM than the App, in order to conclude monetization events 2) there is no need to integrate the app with the OEM. 3) There is no need to share data with the app maker. This includes issues of privacy and potential loss of revenue. 4) No revenue sharing with app owner is needed as the system works independently of the app.

The present disclosure binds together car data and app screen data to generate revenues for the OEM. Of course this is relevant for other cases, other transport methods, computing devices in different situations as car example is easy to explain. But this should not be only relevant to car manufacturers.

Another example for using the technology of the current disclosure is for digital signage which are digital signs in the public, displaying messages, advertisements etc. These digital signs may display still images of clips to the public. It is a threat to the companies running these digital signs that a hacker may be able to hack these digital signs and place their own digital content which would be presented to the public, the contents of which may be threatening or offensive.

The present disclosure is able to analyze the displayed data and come to the conclusion that the actual displayed content is not of the content required by the owner of the digital sign. Following this the decision may be to block the content, restart the application or reboot etc.

This may be done for example, by having the requested content be analyzed or scanned at the initial stage when it is entered to the system. Following this stage the display displays them while the scanning and analysis takes place making sure the displayed contents is indeed the requested contents.

When an anomaly or an unknown image or clip is detected, the display may be blocked or display one or more of the requested images or clips overriding the displayed contents.

It is preferable that the environment which checks for the anomalies or unknown contents or even known malicious contents as well as blocks certain apps on the screen is done in a separate environment to the one the application displaying the images or clips is at, since the attacker that got to that environment may be able to attack the secure system itself. One of the examples is using a separate environment that is unreachable from the app displaying the contents, such as ARM Trustzone environment in FIG. 6, hypervisors, using two separate chips etc.

The blocking of an app or a part of an app on the display may be implemented using the ARM Trustzone environment. In an embodiment, the display driver is handled in the secure world while in the normal world a virtual driver is used. The data from the virtual driver flows to the driver in the secure world through a scanning and analysis chain which analyzes the displayed content, while a function of blocking or replacing pixels or area on the screen follows, receiving commands based on the analysis chain to show or block the display app or part of it. The display data is then sent to the display to display the final result to the user.

Another example for using the present disclosure is for checking if apps have been hacked or have bugs that may affect the end user. We shall call these app anomalies. For example, a satellite application (sat-app) such as Waze may change its destination without user request. This may happen due to a bug, hacking attempt etc. The system in the disclosure can understand the changed destination from analyzing of the displayed app. With added user input scanning ability it may understand if a user requested the changed destination or not. Following the conclusion of a bug or hacking attempt, the system may shut down the application or ask the user to authorize the change for example. The analysis and user request preferably may take place from a location unreachable by the app and preferable from outside the operating system. These may be such as ARM Trustzone environment in FIG. 6, hypervisors, using two separate chips etc.

Another example for using the present disclosure is for identifying malware and false messages displayed on the screen, allowing to identify, warn and block them. For example, an image of known malware and displayed fake messages can be added to a list of searched images. An analysis of the scanned display and a match to parts of images which include the known list can help to identify them and work towards eliminating them. This can be a last line of defense against situations when security systems in place get hacked and the user is exposed with malicious content such as ransomware and fake messages. These messages can then be blocked and OEM made aware so as to begin a session of identifying and resolving the new threat. In the mean time a message from the OEM may be displayed to ask the user to wait and not use their device for example. Another possible mitigation is to reboot the device into safe mode from a clean firmware copy and keep communication to a minimum if any until a solution is found.

With the present disclosure it is possible to follow applications behavior, detect attacks or possible attacks on applications, detect bugs in apps, detect displayed messages to end users. It is then possible to mitigate these attacks. It is also possible to send to SOC information about suspected attacks, requesting more info such as if to whitelist or blacklist a suspected attack so that the system may learn and develop, as well as for reporting purposes. The present application enables checking user input to understand context of app changes and allows questioning the end user for intended request. This present application may understand current app behavior and may, with additional data combined reach conclusions regarding desired actions based on set rules.

This application presents a means of separating means of secure mechanisms from the apps or operating systems it checks, in a way that separates the secure mechanisms from the app and OS, as well as possible interaction with the end user which are made securely in a similar way.

In some embodiments a system is presented for understanding what is displayed on the screen from looking at the screen, in some embodiments from outside the context of the apps or operating system. As a result of such analysis action may be triggered, issues may be whitelisted and blacklisted as well as other actions taken.

### CONCLUSION, RAMIFICATIONS AND SCOPE

Accordingly, the reader will see that the disclosure of this invention provides a system and method for the extraction of data and the binding of data from apps and other available data using separation of systems to generate actions and events as well as detect attacks.

Examples of usage of this disclosure include app data extraction independently of the app maker and a way of using this data with car and/or other data to create events of interest which may allow monetization.

Examples of usage of the disclosure allow to reveal attack attempts and mitigate them to an extent until a full fix is available. It is preferable that during a successful attack that bypassed existing security measures all messages arrive from the OEM and not from the attackers.

Attacks that are revealed and mitigated may be fake messages and ransomware as well as app modifications that normally requires user input to make.

Messages to SOC may be sent for reporting purposes and/or for requesting to whitelist or blacklist a certain message, so the system may learn and develop.

Extracting and analyzing data from app data through displays or other media is used in combination with other data to generate events.

The extraction, analysis and apps may reside in separate environments for security and privacy reasons.

Adding user input data may assist in detecting app bugs and hacking attempts.

Checking of expected data may allow to verify projected data such as for digital signs. Malicious content displayed may be mitigated by identification, notification and immediate blocking of the displayed material.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

It is expected that during the life of this patent many relevant devices and systems for separating sub systems, scanning display and other output, scanning apps and interfacing with apps, other means of identifying unwanted display or other output data to the user and other means of removing that unwanted data and restoring the systems to a working state, other usage examples for understanding what is displayed on the screen, other usage examples of whitelisting and blacklisting certain data displayed on the display will be developed and the scope of the terms herein, particularly of the terms “cloud”, “cloud service”, “ac device”, “dc device”, “dc domain”, “ac domain”, “display”, “identifying”, “filtering”, and “smart vehicles” are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for analyzing and extracting data from apps displayed on a display comprising:
a computing device comprising said display and configured to run said apps within an operating system;
a display scanner for scanning said display externally to said apps displaying on said display;
whereby output of said display scanner is analyzed to extract app data displayed on said display externally to said apps running on said computing device.

2. The system of claim 1 wherein said display scanner operates externally to said operating system whereby output of said display scanner is analyzed to extract app data displayed on said display externally to said operating system running on said computing device.

3. The system of claim 1 wherein said display scanner operates externally to processor of said computing device running said operating system whereby output of said display scanner is analyzed to extract app data displayed on said display externally to said processor running said operating system.

4. The system of claim 1 wherein said display scanner operates externally to said computing device whereby output of said display scanner is analyzed to extract app data displayed on said display externally to said computing device.

5. The system of claim 1 wherein extracted said app data is combined with external data to generate events of interest.

6. The system of claim 1 further comprising data from user input means wherein said input means data is combined with extracted said app data to match app behavior with user input whereby revealing app anomalies.

7. The system of claim 1 wherein extracted data of app of said apps is compared with expected data of said app whereby said app is validated to work as expected.

8. The system of claim 7 wherein said app is invalidated when said comparison of data of said app with said expected data fails whereby at least part of said app is blocked from displaying on said display.

9. The system of claim 7 wherein said app is invalidated when said comparison of data of said app with said expected data fails whereby said app is reported as anomaly.

10. A method of extracting data from apps displaying on a display of a computing device comprising:
a. displaying app data on said display;
b. scanning of said display externally to running of said apps displaying on said display;
c. analyzing scanned display data from said scanning to extract data displayed by said apps.

11. The method according to claim 10 wherein said scanning of said display is external to said computing device whereby scanning of said display is unreachable from said computing device.

12. The method according to claim 10 wherein said scanning of said display is external to operating system running said apps whereby scanning of said display is unreachable from said operating system.

13. The method according to claim 10 wherein said scanning of said display is external to reach of computer processor displaying said app data whereby scanning of said display is unreachable from said computer processor.

14. The method according to claim 10 wherein external data is combined with said extracted data from said apps to generate events of interest.

15. The method according to claim 10 wherein received user input from user input means is combined with said extracted data from said apps to match app behavior with user input whereby revealing app anomalies.

16. The method according to claim 10 wherein extracted data of app of said apps is compared with expected data of said app whereby said app is validated to work as expected.

17. The method according to claim 16 wherein said app is invalidated when said comparison of data of said app with said expected data fails whereby at least part of said app is blocked from displaying on said display.

18. A system for monitoring expected display output comprising:
a computing device comprising a display and configured to display prepared contents;
a display scanner for scanning said display externally to mechanism displaying said contents;
a display blocker for blocking at least part of displayed data on said display.
wherein output of said display scanner is analyzed against said contents to identify data not included in said contents and block at least part of said data from displaying on said display.

19. The system of claim 18 wherein said display scanner is unreachable from context of said mechanism displaying said contents.

20. The system of claim 18 wherein blocking of said displayed data replaces said displayed data with requested contents.
